(19) United States
(12) Patent Application Publication
(10) Pub. No.: US 2017/0167559 A1
(43) Pub. Date: Jun. 15, 2017

(54) STRUCTURE OF MOUNTING BRACKET

(71) Applicant: Hyundai Motor Company, Seoul (KR)

(72) Inventors: Yong-Joo Kim, Hwaseong (KR); Yong-Jin Kim, Gwangmyeong (KR)

(21) Appl. No.: 15/176,500

(22) Filed: Jun. 8, 2016

(30) Foreign Application Priority Data
Dec. 11, 2015 (KR) 10-2015-0177376

(51) Int. Cl. F16F 1/38; B60K 17/00

(52) U.S. Cl. CPC F16F 1/38; B60K 17/00; F16F 2224/02

(57) ABSTRACT

A structure of a mounting bracket that connects a vehicle body and a transmission is provided. The structure includes an outer pipe having an insulator disposed therein and the insulator includes a plurality of stoppers having curved portions and a protrusion formed at an inner top portion of an aperture of the insulator and directed downwards. An inner pipe is coupled in the aperture of the insulator and a core is press-fitted into the inner pipe. The inner pipe and the core abut each other by the protrusion. Accordingly, vehicle dynamics control and quasi-static motion performance are improved, and operational noise, vibration, and noise attributable to vibration are reduced. Since the outer pipe and the inner pipe are made of plastic, the weight of the structure is decreased. Further, a decrease in the gap between stoppers is achieved without a swaging process.

### CROSS-REFERENCE TO RELATED APPLICATION

This application claims the priority benefit of Korean Patent Application No. 10-2015-0177376, filed on Dec. 11, 2015 in the Korean Intellectual Property Office, the disclosure of which is incorporated herein by reference.

### BACKGROUND

1. Field of the invention

The present invention relates to a structure of a mounting bracket, and more particularly to a structure of a mounting bracket, which has improved durability by decreasing a gap between stoppers.

### 2. Description of the Related Art

In general, mounting brackets are used to effectively reduce the transmission of vibration and noise to a vehicle body. Various types of mounts are used between a powertrain and a vehicle body. For example, mount insulators have been used and are types of bushes. A bush is configured with a spring constant tuned based on the angle of a bridge and a gap between stoppers, and influences the control performance and the decrease in vibration and noise of a vehicle based on the characteristics of a load-displacement curve of a rubber spring. Typically, when the gap between stoppers is substantially large, the noise, vibration and harshness (NVH) characteristics, that is, the decrease in noise and vibration, is improved, but the freedom of movement of a power train is increased. In contrast, a minimal gap between stoppers has an effect of decreasing the freedom of movement of a power train, but has a shortcoming of decreasing the insulation performance

When the gap in an insulator is intended to be decreased, the gap is first set to be about 2 to 3 mm due to the characteristics of a curing mold, and is then decreased to 0 mm through contraction using a swaging process after the curing process. Further, to decrease the weight of the components, components made of a steel material are often replaced with components made of aluminum or plastic. However, when an outer steel pipe of a bush is replaced with an outer plastic pipe, the application of a swaging process to a plastic material may be difficult thus causing difficulty in realizing a gap of 0 mm.

### SUMMARY

The present invention provides a structure of a mounting bracket, which has a decreased gap between stoppers, thereby improving vehicle dynamics control and quasi-static motion performance and decreasing operational noise, vibration, and noise attributable to vibration.

In accordance with an aspect of the present invention, the above and other objects can be accomplished by the provision of a structure of a mounting bracket connecting a vehicle body and a transmission, the structure may include an outer pipe having an insulator disposed therein, the insulator may include a plurality of stoppers having curved portions and a protrusion formed at an inner top portion of an aperture of the insulator and directed downwards, an inner pipe coupled in the aperture of the insulator, and a core press-fitted into the inner pipe, the inner pipe and the core being brought into tight contact (e.g., abutting) with each other by the protrusion.

The inner pipe may have a slot formed to correspond to the protrusion to allow the protrusion to be inserted into the slot. The inner pipe may have a width less than a width of the aperture of the insulator, and the core may have a width less than the width of the inner pipe. The outer pipe and the inner pipe may be made of a plastic material, and the protrusion may be made of a rubber material.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view illustrating a structure of a mounting bracket according to an exemplary embodiment of the present invention;

FIG. 2 is a view illustrating a protrusion in the structure of a mounting bracket depicted in FIG. 1 according to an exemplary embodiment of the present invention; and

FIG. 3 is a view illustrating the state in which the structure of a mounting bracket depicted in FIG. 1 is disassembled according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Reference will now be made in detail to the exemplary embodiments of the present invention, examples of which are illustrated in the accompanying drawings. The exemplary embodiments described in the following specification and shown in the accompanying drawings are illustrative only and are not intended to represent all aspects of the invention, so that it is to be understood that various equivalents and modifications may be made without departing from the spirit of the invention.

In the drawings, the same or similar elements are denoted by the same reference numerals even though they are depicted in different drawings. In the following description of the present invention, a detailed description of known functions and configurations incorporated herein will be omitted when it may obscure the subject matter of the present invention. It is to be understood that the phraseology and terminology used in the following specification and appended claims should not be construed as limited to general and dictionary meanings but be construed as the meanings and concepts according to the spirit of the present invention based on the principle that the inventor is permitted to define appropriate terms for the best explanation.

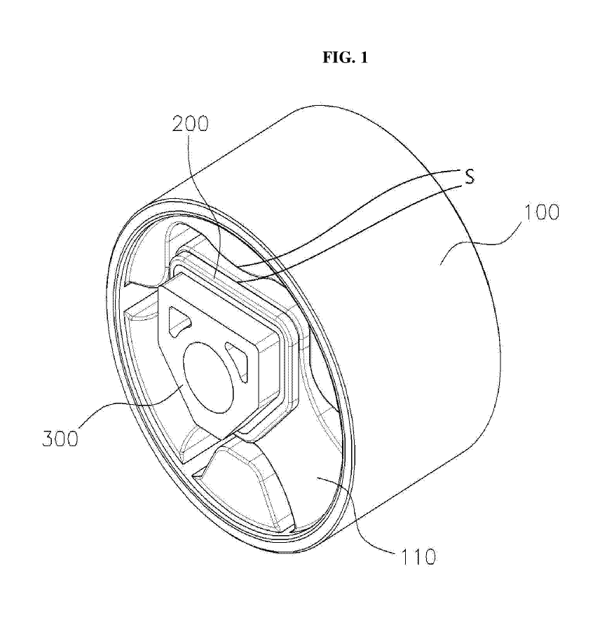

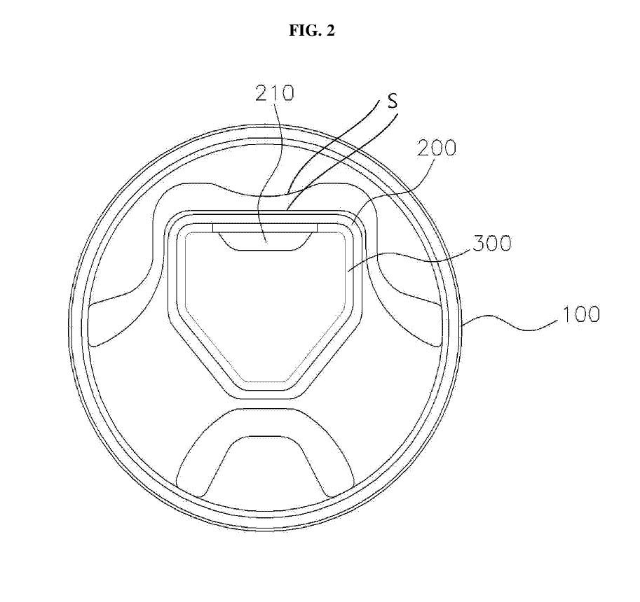

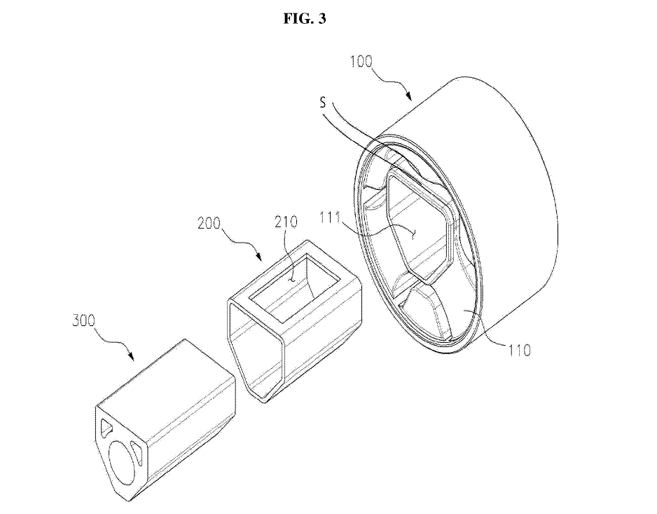

FIG. 1 is a view illustrating a structure of a mounting bracket according to an exemplary embodiment of the present invention, FIG. 2 is a view illustrating a protrusion in the structure of a mounting bracket depicted in FIG. 1, and FIG. 3 is a view illustrating the state in which the structure of a mounting bracket depicted in FIG. 1 is disassembled.

Referring to FIGS. 1 through 3, a structure of a mounting bracket according to an exemplary embodiment of the present invention may be mounted to connect a vehicle body and a transmission, and may have a decreased gap between stoppers S, to improve vehicle dynamics control and quasi-static motion performance and to decrease operational noise, vibration, and noise attributable to vibration. Accordingly, the structure of a mounting bracket may include an outer pipe 100, an inner pipe 200, and a core 300.

Further, the outer pipe 100 may include an insulator 110 disposed therein. The insulator 110 may include a plurality of stoppers S having curved portions. Additionally, the insulator 110 may include a protrusion 112 formed at an inner top portion thereof and directed downwards. The inner pipe 200 may be formed to be coupled in the insulator 110. The inner pipe 200 may further have a slot 210 formed to correspond to the protrusion 112 to allow the protrusion 112 to be inserted into the slot 210. The inner pipe 200 may have a width less than the width of the insulator 110. Therefore, the inner pipe 200 may be inserted into an aperture 111 of the insulator 110. The core 300 of the outer pipe 100 may be press-fitted into the inner pipe 200 and may have a width less than the width of the inner pipe 200.

The above-described structure will now be explained in more detail.

The outer pipe 100 and the inner pipe 200 may be made of a plastic material, and the protrusion 112 may be made of a rubber material or another elastic material. In the press-fitting process, the protrusion 112 may be inserted into the slot 210 of the inner pipe 200, and therefore the inner pipe 200 and the core 300 may brought into tight contact with each other (e.g., may be configured to abut each other, may be in a sealed contact, etc.). That is, the protrusion 112 pushes (e.g., exerts a force onto) the inner pipe 200 against the core 300.

Moreover, since the outer pipe and the inner pipe of the conventional art are made of a steel material, when a gap in the insulator is intended to be decreased, the gap is first set to be about 2 to 3 mm due to the characteristics of a curing mold, and is then decreased to 0 mm through contraction using a swaging process after the curing process. Further, to reduce the overall weight of the assembly, components made of a steel material are replaced with components made of aluminum or plastic. However, when the outer steel pipe of the conventional art is replaced with an outer plastic pipe, a swaging process may be difficult to apply to a plastic material, and therefore it may be difficult to achieve a gap of 0 mm.

In the present invention, the outer pipe 100 and the inner pipe 200 are made of a plastic material and in the gap between the stoppers S is eliminated. Unlike the conventional structure of a mounting bracket, the structure of the present invention includes the outer plastic pipe 100, the inner plastic pipe 200 coupled in the insulator 110, and the aluminum core 300 press-fitted into the inner pipe 200.

Additionally, a slot 210 may be formed at the top portion of the inner pipe 200, and the protrusion 112 having a length of about 2 to 3 mm may be formed at the inner top portion of the insulator 110 and may protrude toward the slot 210. When the aluminum core 300 is press-fitted into the inner pipe 200, the core 300 may push the protrusion 112 outward, thereby eliminating the gap of about 2 to 3 mm between the stoppers S. Accordingly, the decrease in the gap between the stoppers may be achieved without a swaging process.

As is apparent from the above description, the present invention provides a structure of a mounting bracket, in which a gap between stoppers is decreased, thereby improving vehicle dynamics control and quasi-static motion performance. Further, by virtue of the decreased gap between stoppers, operational noise, vibration, and noise attributable to vibration may be reduced in a vehicle dynamics control mode. The structure of a mounting bracket also has a weight-reducing effect due to plastic pipes. In addition, even though a swaging process cannot be applied since the pipes are made of a plastic material, a gap between stoppers may be decreased.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A structure of a mounting bracket that connects a vehicle body and a transmission, comprising:
an outer pipe including an insulator disposed therein, the insulator including a plurality of stoppers having curved portions and a protrusion formed at an inner top portion of an aperture of the insulator and directed downwards;
an inner pipe coupled in the aperture of the insulator; and
a core press-fitted into the inner pipe,
wherein the inner pipe and the core abut each other by the protrusion.

2. The structure of a mounting bracket according to claim 1, wherein the inner pipe includes a slot formed to correspond to the protrusion, the protrusion being inserted into the slot.

3. The structure of a mounting bracket according to claim 1, wherein the inner pipe has a width less than a width of the aperture of the insulator, and the core has a width less than the width of the inner pipe.

4. The structure of a mounting bracket according to claim 1, wherein the outer pipe and the inner pipe are made of a plastic material.

5. The structure of a mounting bracket according to claim 1, wherein the protrusion is made of a rubber material.
